(19) United States
(12) Patent Application Publication
(10) Pub. No.: US 2010/0298046 A1
(43) Pub. Date: Nov. 25, 2010

(54) GAMING SYSTEM

(75) Inventors: Sven Hakan Andersson, Sundbyberg (SE); Christer Hutchinson-Kay, Taby (SE)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia PTY Limited, North Ryde (AU)

(21) Appl. No.: 12/784,210

(22) Filed: May 20, 2010

(30) Foreign Application Priority Data
May 22, 2009 (AU) 2009902304

(51) Int. Cl. A63F 9/24; A63F 13/00

(52) U.S. Cl. 463/26; 463/42; 463/43

(57) ABSTRACT

A gaming system is disclosed which includes a plurality of gaming machines, each gaming machine being arranged to implement a game, a data handling system arranged to communicate with a back end gaming system configured to receive data from the gaming machines, and a communications network arranged to facilitate communications between the gaming machines and the data handling system. The data handling system is arranged to store data received from the gaming machines through the communications network, and to send stored data to the back end system in communication with the data handling system when requested by the back end system. A corresponding method is also disclosed.

### CROSS-REFERENCE TO RELATED APPLICATIONS

The present application relates to and claims the benefit of priority from Australian Provisional Patent Application Number 2009902304, filed on May 22, 2009, which is herein incorporated by reference in its entirety.

### FIELD OF THE INVENTION

The present invention relates to a gaming system.

### BACKGROUND OF THE INVENTION

It is known to provide a gaming system which includes a game controller arranged to implement a game and a player interface usable by a player to play the game.

In some gaming systems which include a plurality of networked gaming machines, the gaming system also includes a back end system which sends communications to and receives communications from the gaming machines over the network. Such communications to the gaming machines may include gaming machine software updates and advertising information, and communications from the gaming machines may include transactional information, player behaviour information, game usage information, game performance information, and so on.

However, for a gaming system of this type which includes several networked gaming machines, the network bandwidth required in order to facilitate such multiple communications between the back office and the gaming machines can become unduly high.

### SUMMARY

In accordance with a first aspect of the present invention, there is provided a gaming system including:

a plurality of gaming machines, each gaming machine being arranged to implement a game;

a data handling system arranged to communicate with a back end gaming system configured to receive data from the gaming machines; and

a communications network arranged to facilitate communications between the gaming machines and the data handling system;

wherein the data handling system is arranged to store data received from the gaming machines through the communications network, and to send stored data to the back end system in communication with the data handling system when requested by the back end system.

In one embodiment, the gaming system includes the back end system, the back end system having at least one back end device. The at least one back end device may include a floor management device, a game management device, a marketing management device, a jackpot management device, a player marketing device, a reporting device, and/or an accounting device.

In one embodiment, the data handling system is arranged to pass a first request by the back end system for specific data from one or more gaming machines to the or each gaming machine, to forward data received in response to the first request from the or each gaming machine to the back end system, and, in response to a subsequent request for the specific data, to retrieve the specific data from the data handling system and send the specific data to the back end device.

In one embodiment, the data handling system is arranged to receive data from the gaming machines, to store the received data at the data handling system and, in response to a request for specific data by the back end system to send the specific data from the data handling system to the back end device. With this arrangement, each gaming machine may be arranged to periodically send data to the data handling system for storage at the data handling system.

In one embodiment, the data handling system is arranged to store game play related data, game accounting related data, and/or game usage related data.

The gaming system may be arranged such that at least one game is implemented across the communications network.

In accordance with a second aspect of the present invention, there is provided a data handling system for a gaming system including a plurality of gaming machines, each gaming machine being arranged to implement a game,

the data handling system being arranged to communicate over a network with a plurality of gaming machines and to receive data over the network from the gaming machines,

the data handling system being arranged to communicate with the back end gaming system configured to request and receive data from the gaming machines, and

the data handling system being arranged to store data received from the gaming machines through the communications network, and to send stored data to the back end system in communication with the data handling system when requested by the back end system.

In accordance with a third aspect of the present invention, there is provided method of handling gaming data in a gaming system including a plurality of gaming machines, said method including:

receiving data over a network from the gaming machines,

storing data received from the gaming machines through the communications network, and

sending stored data to the back end system in communication with the data handling system when requested by the back end system.

In accordance with a fourth aspect of the present invention, there is provided method of gaming including:

providing a plurality of gaming machines, each gaming machine being arranged to implement a game;

providing a data handling system arranged to communicate with a back end gaming system configured to receive data from the gaming machines;

receiving data at the data handling system from at least one gaming machine;

storing data received from the gaming machines at the data handling system; and

sending stored data to the back end system in communication with the data handling system when requested by the back end system.

### BRIEF DESCRIPTION OF THE DRAWINGS

Certain embodiments of the present invention will now be described, by way of example only, with reference to the accompanying drawings, in which:

FIG. 1 is a schematic block diagram of a gaming system in accordance with an embodiment of the present invention;

FIG. 2 is a schematic block diagram a gaming machine of the gaming system shown in FIG. 1;

FIG. 3 is a diagrammatic representation of the gaming machine shown in FIG. 2;

FIG. 4 is a schematic block diagram of operative components of the gaming machine shown in FIG. 2;

FIG. 5 is a schematic block diagram of components of a memory of the gaming machine shown in FIGS. 2; and

FIG. 6 is flow diagram illustrating a method of managing communications in a networked gaming system.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DESCRIPTION OF CERTAIN EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, etc. storing the software and/or firmware.

Referring to the drawings, an embodiment of a networked gaming system 10 is shown which is arranged to implement a probabilistic game at each of a plurality of gaming machines 12. In this example, the probabilistic game is of the type wherein several symbols from a set of symbols are randomly displayed, and a game outcome is determined on the basis of the displayed symbols.

With some such probabilistic games, the set of symbols used include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display along a win line, or are displayed according to defined outcome patterns such as scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

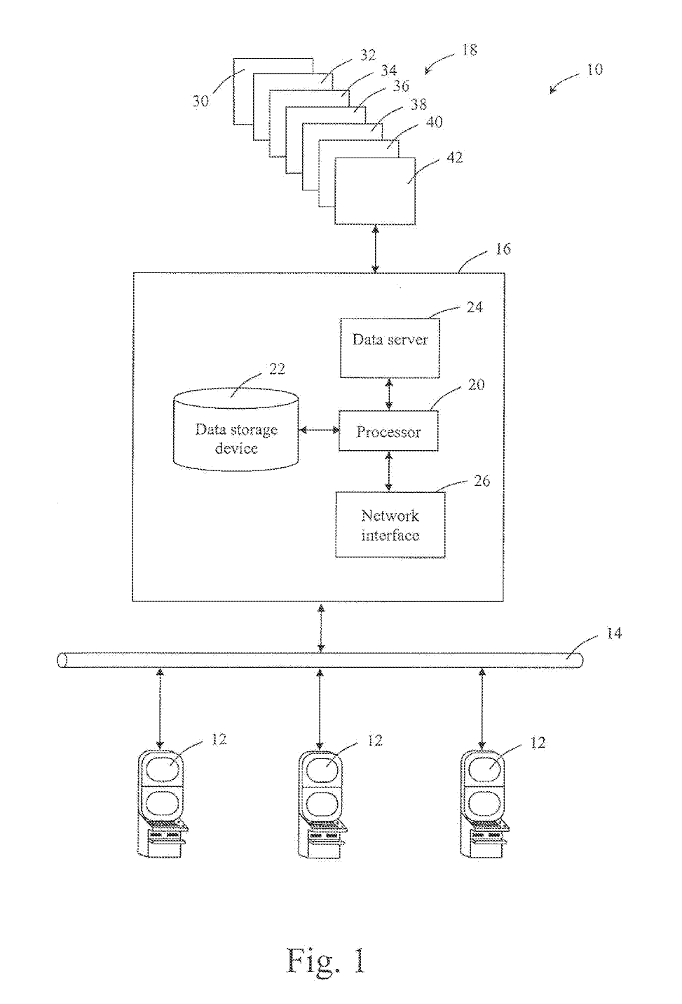

Referring to FIG. 1, a schematic diagram of a gaming system 10 in accordance with the present embodiment is shown. The gaming system 10 includes several gaming machines 12 connected together in networked relationship using a data network 14, a data handling device 16 connected to the network 14, and a back end system 18 arranged to send communications to and receive communications from the gaming machines 12.

The data handling device 16 is disposed between the network 14 and the back end system 18 and is arranged to receive communications from the gaming machines 12 and forward the communications to one or more back end devices when requested. In this example, the data handling device 16 includes a processor 20 for controlling and coordinating operations in the data handling device 16, a storage device 22 for storing data received from the gaming machines, a data server 24 arranged to serve data to the back end system 18 under control of the processor 20, and a network interface 26 arranged to interface with the network 14 and facilitate communications between the data handling device 16 and the network 14.

In this example, the back end system 16 includes multiple back end devices including a floor management device 30 arranged to monitor and optimise performance of games at a gaming venue; a game management device 32 arranged to manage games implemented by the gaming machines 12, for example so as to download games to the gaming machines 12 or update gaming machine software; a marketing management device 34 arranged to distribute marketing information such as advertising material to the gaming machines 12; a jackpot management device 36 arranged to manage implementation of jackpots associated with the gaming machines 12, such as progressive jackpots; a player marketing device 38 arranged to receive information from player marketing modules at the gaming machines 12 and to use the information to monitor player behaviour; a reporting device 40 arranged to create reports relating to, for example, financial settlements, marketing initiatives and sales figures using, at least in part, information received from the gaming machines 12; and an accounting device 42 arranged to carry out accounting functions using, at least in part, information received from the gaming machines 12.

The gaming system 10 is arranged such that games are implemented by the gaming machines 12, either alone or in association with the back end system 18, and information communicated from the gaming machines 12 to the back end system 18 through the network 14 is stored in the data storage device 22 and subsequently forwarded to a back office device when the information is requested by the back office device 22.

This may occur in various ways. For example, in one embodiment, when a back end device requests specific information from one or more gaming machines 12, the information is sent from the gaming machines 12 through the network 14 to the requesting back end device and a copy of the information is stored in the data storage device 22. If the information is subsequently requested by one or more further back end devices, the requested information stored in the data storage device is sent from the data storage device 22 to the requesting back end device.

In an alternative embodiment, the gaming devices are automatically configured to send information to the back end system 18 periodically. With this embodiment, when the information is received at the data handling device 16, the information is stored in the data storage device 22 and the information is subsequently sent from the data storage device to a back end device on request.

It will be appreciated that since information which may be required by more than one back end device is sent through the network 14 only once, the amount of traffic over the network 14 during use is reduced compared to systems known hitherto wherein a communication is often sent across the network more than once in response to requests by multiple back end devices.

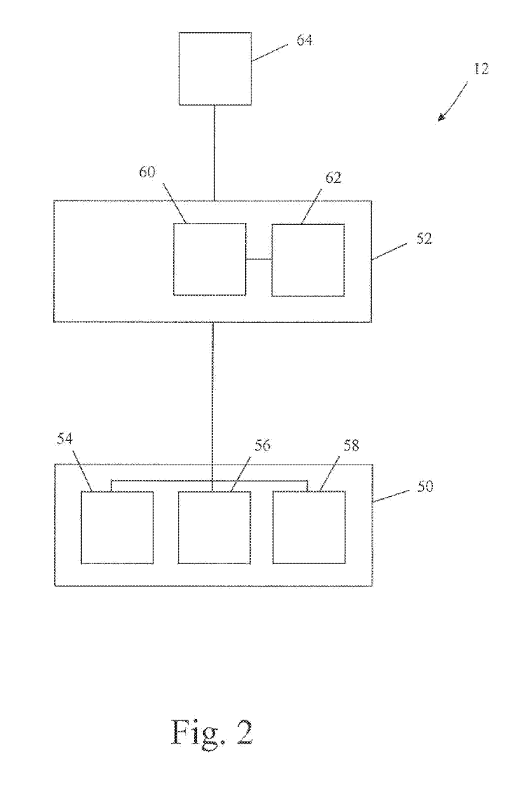

An embodiment of a gaming machine 12 is shown in block diagram form in FIG. 2. The gaming machine 12 includes a player interface 50 and a game controller 52. The player interface 50 is arranged to enable interaction between the gaming system and a player or gaming machine operator and for this purpose includes input/output components for the player to enter instructions and play the game and for the operator to gain access to a parameters menu and make changes to gaming machine parameters as required.

Components of the player interface 50 may vary but will typically include a credit mechanism 54 to enable a player to input credits and receive payouts, one or more displays 56 which may include a touch screen, and a game play mechanism 58 arranged to enable a player to input instructions.

The game controller 52 is in data communication with the player interface 50 and typically includes a processor 60 arranged to process game play instructions and output game player outcomes to the display 56. Typically, the game play instructions are stored as program code in a memory 62 that can also be hardwired. It will be understood that in this specification the term “processor” is used to refer generically to any device that can process game play instructions and may include a microprocessor, microcontroller, programmable logic device or other computational device such as a personal computer or a server.

The gaming machine 12 also includes a network interface 64 arranged to facilitate communications between the gaming machine 12 and the network 14 under control of the processor 60.

The gaming system 10 can take a number of different forms.

In a first form, gaming machines are provided wherein all or most components to implement a game are present in the gaming machine.

In a second form, a distributed architecture is provided wherein some of the components to implement a game are present in a player operable gaming machine and some of the components to implement the game are located remotely relative to the gaming machine, such as at the back end system 18 as shown in FIG. 1. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

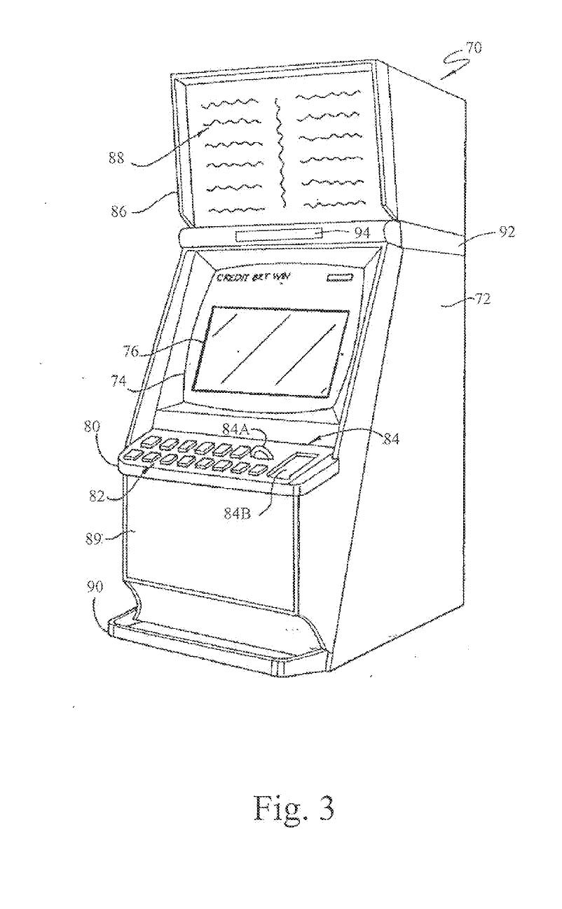

A gaming system in the form of a stand alone gaming machine 70 is illustrated in FIG. 3. The gaming machine 70 includes a console 72 having a display 74 on which is displayed representations of a game 76 that can be played by a player. A mid-trim 80 of the gaming machine 70 houses a bank of buttons 82 for enabling a player to interact with the gaming machine, in particular during game play. The mid-trim 80 also houses a credit input mechanism 84 which in this example includes a coin input chute 84A and a bill collector 84B. Other credit input mechanisms may also be employed, for example, a card reader for reading a smart card, debit card or credit card.

A top box 86 may carry artwork 88, including for example pay tables and details of bonus awards and other information or images relating to the game. Further artwork and/or information may be provided on a front panel 89 of the console 72. A coin tray 90 is mounted beneath the front panel 89 for dispensing cash payouts from the gaming machine 70.

The display 74 is in the form of a video display unit, particularly a cathode ray tube screen device. Alternatively, the display 74 may be a liquid crystal display, plasma screen, or any other suitable video display unit. The top box 86 may also include a display, for example a video display unit, which may be of the same type as the display 74, or of a different type. The display 74 may include a touch screen usable by a player to interact with the gaming machine, in particular during game play, and to interact with the system menu in order to display a parameters menu usable to access and modify parameters associated with one or more gaming machines.

The display 74 in this example is arranged to display representations of several reels, each reel of which has several associated symbols. During operation of the game, the reels first appear to rotate then stop with at least one symbol visible on each reel. Game outcomes are determined on the basis of the visible symbols together with any special functions associated with the symbols.

A player marketing module (PMM) 92 having a display 94 is connected to the gaming machine 70. The main purpose of the PMM 92 is to allow the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 92 is a Sentinel III device produced by Aristocrat Technologies Pty Ltd.

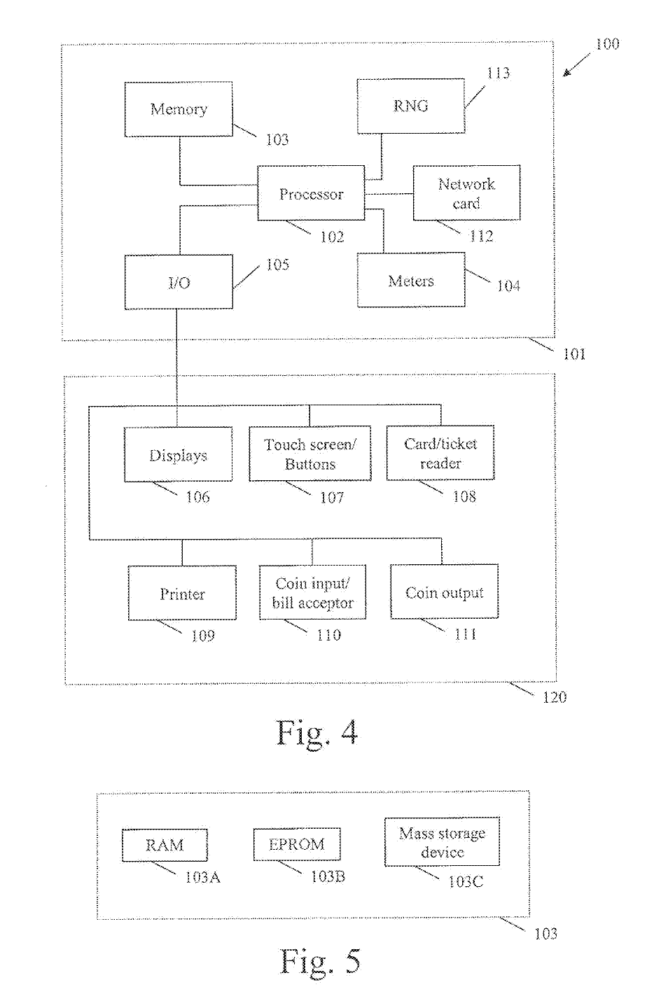

FIG. 4 shows a block diagram of operative components of a gaming machine 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game and service programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 3, the peripheral devices that communicate with the game controller 101 include one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card is arranged to send status information, transaction information, game usage information, accounting information or any other game related information to the data handling system 16 for use by the back end system 18, and to receive data through the network 14, which may include new game software, software updates or any other game related data.

In an alternative embodiment, the PMM 92 may in addition or alternatively be used to send communications to the data handling system 16 for use by the back end system 18.

It is also possible for the operative components of the gaming machine 100 to be distributed, for example input/output devices 106,107,108,109,110,111 may be provided remotely from the game controller 101.

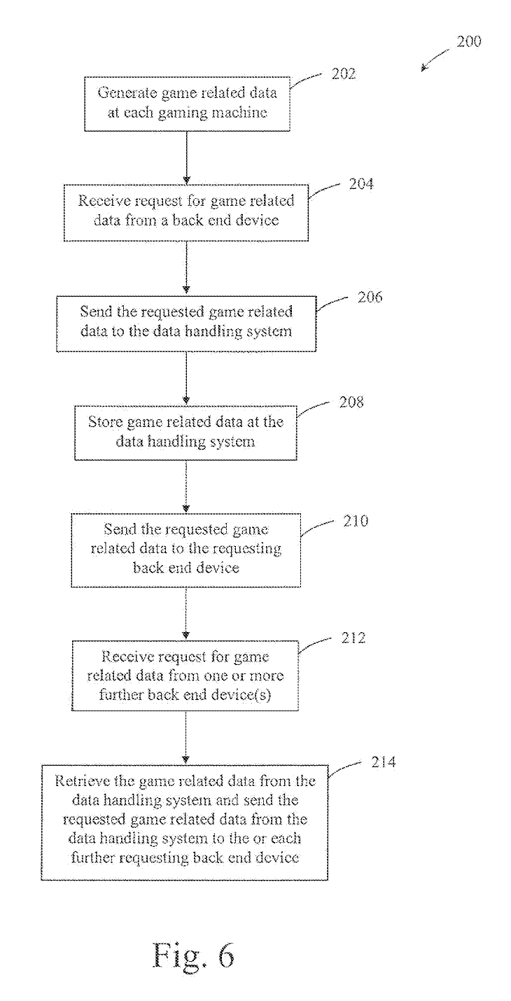

An example of a specific implementation of a gaming system will now be described with reference steps 202 to 214 of flow diagram 200 in FIG. 6.

FIG. 6 illustrates a flow diagram for an example method 200 for game play. FIG. 6 depicts an example flow diagram representative of processes that may be implemented using, for example, computer readable instructions that may be used to facilitate reviewing of anatomical images and related clinical evidence. The example processes of FIG. 6 may be performed using a processor, a controller and/or any other suitable processing device. For example, the example processes of FIG. 6 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 6 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 6 may be implemented manually or as any combination(s) of any of the foregoing techniques, for example, any combination of firmware, software, discrete logic and/or hardware. Further, although the example processes of FIG. 6 are described with reference to the flow diagram of FIG. 6, other methods of implementing the processes of FIG. 6 may be employed. For example, the order of execution of the blocks may be changed, and/or some of the blocks described may be changed, eliminated, sub-divided, or combined. Additionally, any or all of the example processes of FIG. 6 may be performed sequentially and/or in parallel by, for example, separate processing threads, processors, devices, discrete logic, circuits, etc.

During operation, the gaming system implements a game in response to player input at one or more of the gaming machines 12. The game may be implemented solely by a gaming machine, or at least partly by the gaming machine and at least partly by a remote server, for example a game server which forms part of the back end system 16.

In this example, during use each gaming machine 12 associated with the gaming system 10 generates 202 game related data for use by one or more of the back end devices. When requested 204 by a back end device for game related data, a gaming machine 12 sends 206 the requested game related data to the data handling system 16 and the data handling system 16 stores 208 the game related data at the data handling device, in this example in the data storage device 22. The game related data is also forwarded 210 to the requesting back end device. When subsequent requests are received 212 from other back end devices, the data handling device 16 retrieves the game related data from the data storage device 22 and forwards 214 the retrieved game related data to the or each requesting back end device.

It will be appreciated by persons skilled in the art that numerous variations and/or modifications may be made to the invention as shown in the specific embodiments and/or aspects without departing from the spirit or scope of the invention as broadly described. For example, it will be apparent that certain features of the invention can be combined to form further embodiments. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system comprising:
a plurality of gaming machines, each gaming machine being arranged to implement a game;
a data handling system arranged to communicate with a back end gaming system configured to receive data from the gaming machines; and
a communications network arranged to facilitate communications between the gaming machines and the data handling system;
wherein the data handling system is arranged to store data received from the gaming machines through the communications network, and to send stored data to the back end system in communication with the data handling system when requested by the back end system.

2. A gaming system as claimed in claim 1, comprising the back end system, the back end system having at least one back end device.

3. A gaming system as claimed in claim 2, wherein the at least one back end device comprises a floor management device, a game management device, a marketing management device, a jackpot management device, a player marketing device, a reporting device, and/or an accounting device.

4. A gaming system as claimed in claim 2, wherein the data handling system is arranged to pass a first request by the back end system for specific data from one or more gaming machines to the or each gaming machine, to forward data received in response to the first request from the or each gaming machine to the back end system, and, in response to a subsequent request for the specific data, to retrieve the specific data from the data handling system and send the specific data to the back end device.

5. A gaming system as claimed in claim 1, wherein the data handling system is arranged to receive data from the gaming machines, to store the received data at the data handling system and, in response to a request for specific data by the back end system, to send the specific data from the data handling system to the back end device.

6. A gaming system as claimed in claim 5, wherein each gaming machine is arranged to periodically send data to the data handling system for storage at the data handling system.

7. A gaming system as claimed in claim 1, wherein the data handling system is arranged to store game play related data, game accounting related data, and/or game usage related data.

8. A gaming system as claimed in claim 1, wherein the gaming system is arranged such that at least one game is implemented across the communications network.

9. A data handling system for a gaming system comprising a plurality of gaming machines, each gaming machine being arranged to implement a game,
the data handling system being arranged to communicate over a network with a plurality of gaming machines and to receive data over the network from the gaming machines,
the data handling system being arranged to communicate with a back end gaming system configured to request and receive data from the gaming machines, and
the data handling system being arranged to store data received from the gaming machines through the communications network, and to send stored data to the back end system in communication with the data handling system when requested by the back end system.

10. A gaming system as claimed in claim 9, wherein the data handling system is arranged to pass a first request by the back end system for specific data from one or more gaming machines to the or each gaming machine, to forward data received in response to the first request from the or each gaming machine to the back end system, and, in response to a subsequent request for the specific data, to retrieve the specific data from the data handling system and send the specific data to the back end device.

11. A gaming system as claimed in claim 9, wherein the data handling system is arranged to receive data from the gaming machines, to store the received data at the data handling system and, in response to a request for specific data by the back end system, to send the specific data from the data handling system to the back end device.

12. A gaming system as claimed in claim 9, wherein the data handling system is arranged to store game play related data, game accounting related data, and/or game usage related data.

13. A method of gaming comprising:
providing a plurality of gaming machines, each gaming machine being arranged to implement a game;
providing a data handling system arranged to communicate with a back end gaming system configured to receive data from the gaming machines;
receiving data at the data handling system from at least one gaming machine;
storing data received from the gaming machines at the data handling system; and
sending stored data to the back end system in communication with the data handling system when requested by the back end system.

14. A method as claimed in claim 13, wherein the back end system comprises a floor management device, a game management device, a marketing management device, a jackpot management device, a player marketing device, a reporting device, and/or an accounting device.

15. A method as claimed in claim 13, comprising:
passing a first request by the back end system for specific data from one or more gaming machines to the or each gaming machine;
forwarding data received in response to the first request from the or each gaming machine to the back end system; and
in response to a subsequent request for the specific data, retrieving the specific data from the data handling system and sending the specific data to the back end device.

16. A method as claimed in claim 13, comprising:
receiving data from the gaming machines;
storing the received data at the data handling system and;
in response to a request for specific data by the back end system, sending the specific data from the data handling system to the back end device.

17. A method as claimed in claim 16, comprising periodically sending data from each gaming machine to the data handling system for storage at the data handling system.

18. A method as claimed in claim 13, comprising storing game play related data, game accounting related data, and/or game usage related data at the data handling system.

19. A method of handling gaming data in a gaming system comprising a plurality of gaming machines, said method comprising:
receiving gaming data over a communications network from the gaming machines,
storing data received through the communications network from the gaming machines, and
sending stored data to a back end system in communication with the data handling system when requested by the back end system.

20. A method as claimed in claim 13, wherein the gaming data is associated with a floor management device, a game management device, a marketing management device, a jackpot management device, a player marketing device, a reporting device, and/or an accounting device.

21. A method as claimed in claim 19, comprising:
passing a first request by the back end system for specific data from one or more gaming machines to the or each gaming machine;
forwarding data received in response to the first request from the or each gaming machine to the back end system; and
in response to a subsequent request for the specific data, retrieving the specific data from the data handling system and sending the specific data to the back end device.

22. A method as claimed in claim 19, comprising:
receiving data from the gaming machines;
storing the received data at the data handling system and;
in response to a request for specific data by the back end system, sending the specific data from the data handling system to the back end device.

23. A method as claimed in claim 22, comprising periodically sending data from each gaming machine to the data handling system for storage at the data handling system.

24. A method as claimed in claim 19, comprising storing game play related data, game accounting related data, and/or game usage related data at the data handling system.

25. A tangible computer readable medium comprising computer program code which, when executed, implements a method of handling gaming data in a gaming system comprising a plurality of gaming machines, said method comprising:
receiving gaming data over a communications network from the gaming machines,
storing data received through the communications network from the gaming machines, and
sending stored data to a back end system in communication with the data handling system when requested by the back end system.
